(19) United States
(12) Patent Application Publication
(10) Pub. No.: US 2026/0331876 A1
(43) Pub. Date: Oct. 22, 2026

(54) ARRANGEMENT FOR AN INTERNAL COMBUSTION ENGINE COMPRISING AN IGNITER FOR IGNITING AN AIR FUEL MIXTURE

(71) Applicant: INNIO Jenbacher GmbH & Co OG, Jenbach (AT)

(72) Inventors: Thomas Fankhauser, Finkenbert (AT); Wolfgang Fimml, Maurach in Tirol (AT); Rafal Pyszczek, Warschau (PL); Matthias Raibel, Innsbruck (AT); Adam Weall, Jenbach (AT)

(21) Appl. No.: 19/654,442

(22) Filed: Apr. 21, 2026

(30) Foreign Application Priority Data
Apr. 22, 2025 (EP) 25171701

(51) Int. Cl. H01T 13/08; F02B 19/12

(52) U.S. Cl. CPC H01T 13/08; F02B 19/12

(57) ABSTRACT

Arrangement for an internal combustion engine comprising an igniter for igniting an air fuel mixture, in particular a spark plug, with a longitudinal axis and a component part for receiving at least part of the igniter, wherein the igniter is disposed in the component part in a given azimuthal position relative to the longitudinal axis, wherein there is provided a positioning device functioning to lock the igniter in the given azimuthal position.

### CROSS-REFERENCE TO RELATED APPLICATION

This application claims priority to and benefit of European Patent Application No. EP 25171701.3, filed on Apr.22, 2025, entitled “ARRANGEMENT FOR AN INTERNAL COMBUSTION ENGINE COMPRISING AN IGNITER FOR IGNITING AN AIR FUEL MIXTURE”, which is herein incorporated by reference in its entirety for all purposes.

### FIELD OF THE INVENTION

The present disclosure concerns an arrangement for an internal combustion engine comprising an igniter for igniting an air fuel mixture, in particular a spark plug, with the features of the preamble of claim 1 and an igniter, in particular spark plug, for an internal combustion engine as well as an internal combustion engine having such an arrangement and/or igniter.

### BACKGROUND

In the following the state of the art will be outlined with making reference to embodiments, wherein the igniter provided by spark plugs. But the same issues and conditions apply generally to igniters, such as laser spark plugs.

During operation of an internal combustion engine in the combustion process an air-fuel mixture in the combustion chamber is ignited and combusted, wherein during the combustion the expansion of the high-temperature and high-pressure gases are mainly used and transmitted into mechanical energy.

To increase the efficiency, it is desirable to improve the ignition process, wherein it would be preferable if the whole or as much as possible air-fuel mixture inside the combustion process ignites at the same time.

Starting from a certain size of internal combustion engines, in particular gas engines, it is beneficial to use ignition amplifiers, in order to properly ignite the air-fuel-mixture, preferably a diluted and/or lean air-fuel-mixture, in the large volume of the cylinders.

Pre-chambers usually serve as these ignition intensifiers, wherein the fuel-air mixture that is highly compressed at the end of the compression stroke is ignited in a relatively small secondary space (a pre-chamber volume) separate from the main combustion chamber of the cylinders, wherein the combustion of the pre-chamber passes over, e.g. via transfer passages fluidically connecting the pre-chamber volume with the main combustion chamber, into the main combustion chamber and ignites the compressed air-fuel mixture in the main combustion chamber.

But furthermore, also in operation oof pre-chambers it would be beneficial to generate an ideally high (combustion) pressure to generate preferably quick and long ignition torches passing via the transfer passages into the main combustion chamber.

Therefore, it is known by the state of the art to provide pre-chambers having pear shaped pre-chamber volume geometries, wherein a spark plug is arranged centrical in the upper part of the pre-chamber volume to provide a symmetrical ignition which study moves downward in direction of the transfer passages.

But it is still desirable to develop new techniques for providing more effective solutions for igniting air-fuel mixtures in combustion chambers of the internal combustion engines.

### BRIEF DESCRIPTION

Therefore, the object of the present disclosure is to provide an arrangement for an internal combustion engine comprising an igniter for igniting an air fuel mixture, in particular a spark plug, with improved and/or more efficient ignition.

This object is achieved by an arrangement for an internal combustion engine comprising an igniter for igniting an air fuel mixture, in particular a spark plug, with the features of claim 1 and an igniter, in particular spark plug, for an internal combustion engine as well as an internal combustion engine comprising such an arrangement and/or igniter.

Accordingly, an arrangement for an internal combustion engine comprising an igniter for igniting an air fuel mixture, in particular a spark plug, with a longitudinal axis and a component part for receiving at least part of the igniter, wherein the igniter is disposed in the component part in a given azimuthal position relative to the longitudinal axis, wherein there is provided a positioning device functioning to lock the igniter in the given azimuthal position.

Tests of the applicant have surprisingly shown that the combustion process can be improved by igniting an air-fuel mixture by an ignition provided eccentrically in an upper region of the combustion chamber.

Such an eccentrical igniting does initiate a combustion process firstly spreading in the upper region around the whole circumference of the combustion chamber before burning down along the combustion chamber, wherein a much higher efficiency of the combustion process can be achieved.

For this reason, it is desirable to locate the ignition event eccentrically in a desired position of the combustion chamber.

By use of the positioning device functioning to lock the igniter in the given azimuthal position the igniter can exactly be arranged relatively to the component part, especially with regard to a rotational position.

Such an exactly positioning of the igniter allows to orient the igniter to given thermal and/or fluidical properties already being present in the combustion chamber, wherein this thermal and/or fluidical properties can be used to actively affect the thermal impact on the igniter during the combustion process.

It can be provided that the azimuthal position provides a relative positioning between the igniter and the component part, that an given fluidically flow in or through the combustion chamber (for instance an air, fuel or air-fuel mixture supplied into the combustion chamber) is directed at the igniter, e.g., the spark gap of the igniter, wherein the fluid flow (especially between the combustion strokes) can be used to actively affect (preferably cool) the igniter.

Therefore, in an exemplary embodiment, air, fuel or air-fuel mixture supplied to the combustion chamber or a pre-chamber can be used for active cooling of the igniter, preferably the spark plug.

The igniter particularly preferably can be provided by a spark plug comprising electrodes for creating an ignition spark, wherein a possibility is provided to actively cool the electrodes of the spark plug and therefore provide an alternative or additional way of heat dissipation.

In other embodiments the igniter is configured to focus a laser beam onto the ignition area for creating the ignition energy in the ignition area (laser spark plug). In such embodiments also a supplied air, fuel or air-fuel mixture can be used to actively cool the components near the ignition area when the fuel and/or air is conveyed through.

The given azimuthal position of the igniter relative to the longitudinal axis according to the present disclosure can be understood as the angular position of the igniter given the longitudinal axis as turning axis.

The longitudinal axis can in many instances be an axis along which a translation happens when the igniter is screwed into a thread in the cylinder head or spark plug sleeve.

Advantageous embodiments of the disclosure are defined in the dependent claims.

It can be provided that the positioning device is securable or secured in the component part and/or integral with the component part.

The positioning device can be provided by a latch, preferably with a longitudinal extension along a centerline of the latch, particularly preferably wherein the centerline of the latch is provided oblique or orthogonal with respect to the longitudinal axis of the igniter

The latch can be provided in the form of a pin or by a grub screw.

The positioning device can be provided by a locking profile disposed on the igniter, wherein the latch and the locking profile cooperate for locking the igniter in the given azimuthal position.

The locking profile can be provided by a recess, preferably a groove and/or a bore.

The component part can be provided by a spark plug sleeve or a pre-chamber sleeve disposing the igniter in such a way, that an ignition device of the igniter protrudes into a combustion chamber and/or a pre-combustion chamber of the internal combustion chamber.

It can be provided that the component part carries or provides a pre-chamber component part and the igniter is configured to ignite a combustible air-fuel mixture inside a pre-chamber volume of the pre-chamber component part.

At least one pre-chamber gas channel can be provided for supplying air, fuel or an air-fuel mixture to the pre-chamber volume.

It can be provided that the component part comprises the at least one pre-chamber gas channel, preferably the at least one pre-chamber gas channel can be provided by at least one bore at least partially through the component part.

It can be provided that the pre-chamber gas channel provides a fluid connection to a pre-chamber gas valve or a pre-chamber gas injector.

The igniter can be provided by at least one middle electrode and at least one ground electrode, wherein between the at least one middle electrode and the at least one ground electrode a spark gap is present.

The given azimuthal position of the igniter can be provided in such a way that the supplied air, fuel or an air-fuel mixture via the pre-chamber gas channel is directed to the spark gap, middle electrode and/or ground electrode when entering the pre-chamber.

It can be provided that an exit part of the pre-chamber gas channel is aligned with the spark gap, middle electrode and/or ground electrode when the igniter is in the given azimuthal position.

Protection is also sought for an igniter, in particular a spark plug, particular preferred an igniter of an arrangement according to the present disclosure, for an internal combustion engine with a longitudinal axis which comprises at least part of a positioning device which functions to lock the igniter in a given azimuthal position relative to the longitudinal axis in state when the igniter is mounted in a component part of the internal combustion engine.

Furthermore, protection is sought for an internal combustion engine comprising an arrangement and/or an igniter according to the present disclosure.

### BRIEF DESCRIPTION OF THE DRAWINGS

Further details and advantages are apparent from the accompanying figures and the following description of the drawings. The figures show:

FIG. 1 illustrates a first embodiment of an arrangement for an internal combustion engine comprising an igniter,

FIG. 2 illustrates a second embodiment of an arrangement for an internal combustion engine comprising an igniter,

FIG. 3 illustrates a third embodiment of an arrangement for an internal combustion engine comprising a spark plug,

FIG. 4 illustrates a detail view of FIG. 3, and

FIG. 5 illustrates the spark plug of FIG. 4 and 5 in isolation.

### DETAILED DESCRIPTION

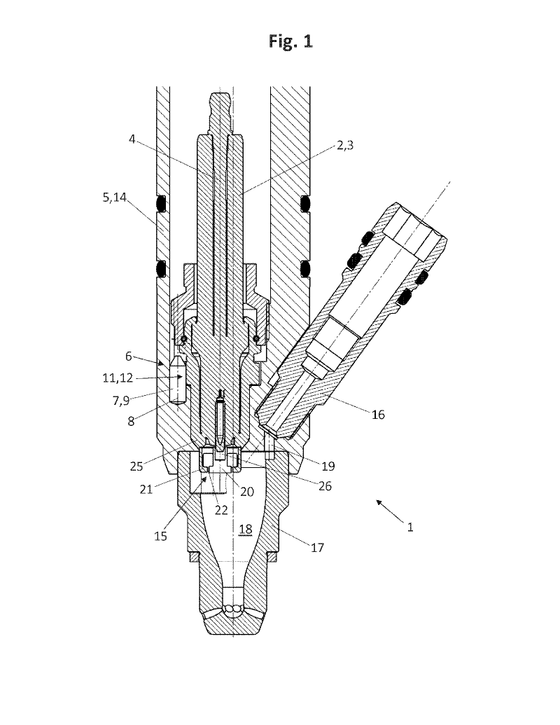

FIG. 1 discloses a first embodiment of an arrangement 1 for an internal combustion engine comprising an igniter 2, wherein the igniter 2 of this embodiment is provided by a spark plug 3.

The pre-chamber volume 18 shown by this specific embodiment is formed by two separate components which form a cavity in the mounted state. The upper part forming the pre-chamber volume 18 is a spark plug sleeve 14 and the lower part a pre-chamber component part 17 which are connected.

The spark plug sleeve 14 and the pre-chamber component part 17 are placed in a cylinder head (not shown for reasons of clarity) of an internal combustion engine, wherein the pre-chamber component part 17 (forming the distal end of the arrangement 1) protrudes into a main combustion chamber of the internal combustion chamber.

The spark plug sleeve 14 carries the pre-chamber injector 16 and the spark plug 3, wherein the spark plug sleeve 14 comprises an upper opening which forms the proximal end of the arrangement 1.

The pre-chamber injector 16 is fluidically connected to the pre-chamber gas channel 19.

By use of the pre-chamber gas channel 19 and the pre-chamber injector 16 air, fuel or and air-fuel-mixture can be supplied to the pre-chamber volume 18.

The pre-chamber gas channel 19 is arranged partially arranged in the spark plug sleeve 14 and partially arranged in the pre-chamber component part 17.

The spark plug 3 is mounted at the spark plug sleeve 14 disposing the spark plug 3 in such a way, that an ignition device 15 of the spark plug 3 protrudes into the pre-combustion volume 18 of the internal combustion chamber.

In this embodiment the spark plug 3 providing the igniter 2 is provided inside the spark plug sleeve 14, which spark plug sleeve 14 provides the component part 5.

The spark plug 3 comprises a middle electrode 20 and ground electrodes 21, wherein between the middle electrode 20 and the ground electrodes 21 a spark gap 22 is present.

Furthermore, the spark plug 3 and the spark plug sleeve 14 are provided by a positioning device 6 functioning to lock the spark plug 3 in the given azimuthal position.

The positioning device 6 comprises a latch 7 with a longitudinal extension along a centerline 8 of the latch 7, wherein the centerline 8 of the latch 7 is provided parallel with respect to the longitudinal axis 4 of the spark plug 3.

The latch 7 of the embodiment of FIG. 1 is provided by a pin 9.

Furthermore, the positioning device 6 comprises a locking profile 11 disposed on the spark plug 3, wherein the pin 10 and the locking profile 11 cooperate for locking the spark plug 3 in the given azimuthal position.

The locking profile 11 of this embodiment is provided by a groove 12, wherein the groove 12 is manufactured at the spark plug 3, preferably by milling.

The given azimuthal position of the spark plug 3 is provided in such a way that the supplied air, fuel or an air-fuel mixture via the pre-chamber gas channel 19 is directed to the spark gap 22, the middle electrode 20 and the ground electrode 21 when entering the pre-chamber volume 18.

Therefore, the air, fuel or air-fuel mixture supplied to the pre-chamber volume 18 can be used for active cooling of the ignition device 15, wherein a possibility is provided to actively cool the ignition device 15 of the spark plug 3 and therefore provide an alternative or additional way of heat dissipation from the spark plug 3.

By use of such a configuration the electrodes 20, 21 of the spark plug 3 effected to the highest thermal conditions can be cooled in the most effective way.

By positioning the spark plug 3 in a given azimuthal position the ignition between the electrodes 20, 21 can be positioned exactly, wherein an ideal position of the start of ignition can be provided.

By providing an ignition eccentrically in an upper region of the pre-combustion volume 18 the combustion process firstly spreads in the upper region around the whole circumference of the pre-combustion volume 18 before burning down along the longitudinal axis 4, wherein a much higher efficiency of the combustion process can be achieved.

By use of a nearly symmetrical expansion of the combustion process downward along the longitudinal axis 4 a much higher combustion peak pressure inside the pre-chamber volume 18 can be reached, wherein the flame jet passing through the transfer passages 23 into a main combustion chamber of an internal combustion engine to ignite an air-fuel mixture in the main combustion chamber can be increased regarding their speed an length entering the main combustion chamber of the internal combustion engine.

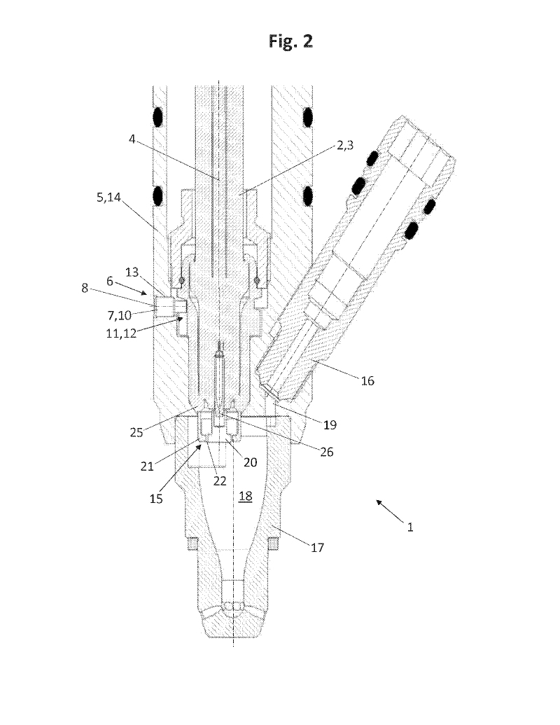

FIG. 2 discloses a second embodiment of an arrangement 1 for an internal combustion engine comprising an igniter 2, wherein the igniter 2 of this embodiment is provided by a spark plug 3.

In contrast to the embodiment of FIG. 1 the second embodiment disclosed of FIG. 2 discloses different positioning device 6, wherein the positioning device 6 comprises a latch 7 with a longitudinal extension along a centerline 8, wherein the centerline 8 of the latch 7 is provided oblique or orthogonal with respect to the longitudinal axis 4 of the igniter 2.

The latch 7 is provided in this embodiment in the form of a grub screw 10, screwed or arranged inside a bore 13 of the spark plug sleeve 14.

The grub screw 10 can be screwed against or inside the groove 12 (functioning as the locking profile 11) of the spark plug 3.

Therefore, the first embodiment of FIG. 1 and the second embodiment of FIG. 2 manly differ by the positioning device 6 (comprising the latch 7 and the locking profile 11). The remaining characteristics are essentially the same.

FIGS. 1 and 2 disclose embodiments of arrangements comprising spark plugs 3 known in the state of the art having a symmetric arrangement of the electrodes 20, 21.

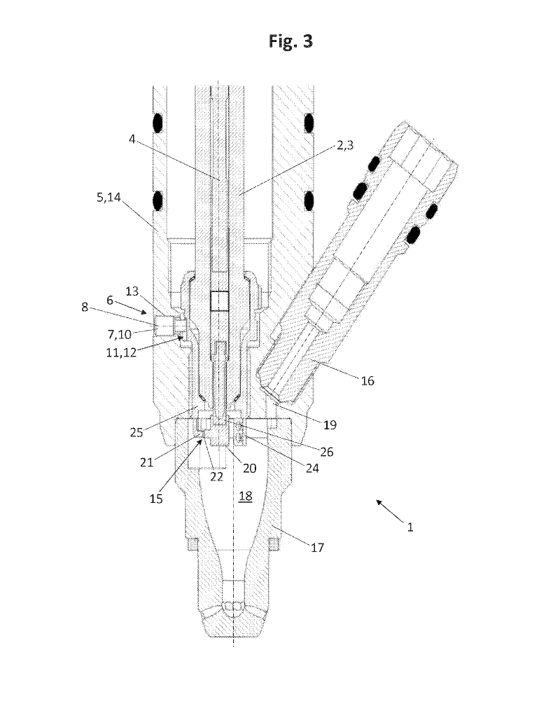

FIG. 3 discloses an arrangement (especially compared to FIG. 2) having a different Type of a spark plug 3).

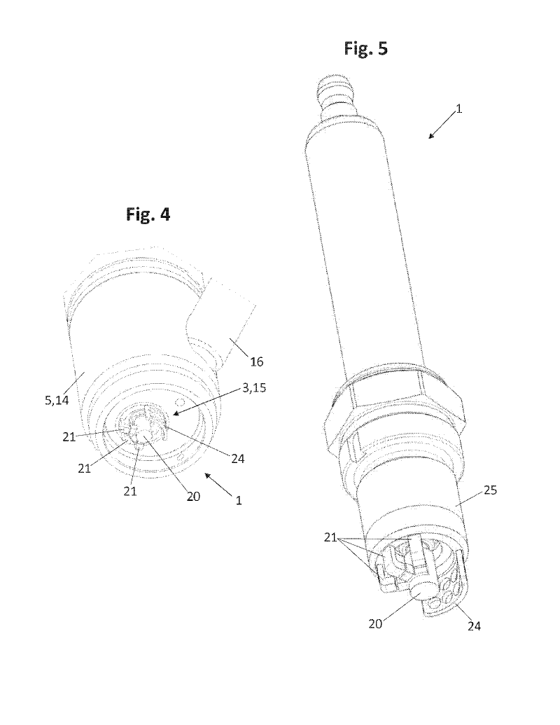

This spark plug 3 arranged inside the spark plug sleeve 14 is furthermore shown by FIG. 4 in a perspective view, wherein the pre-chamber component part 17 is hidden to provide a direct view from side of the combustion chamber onto the spark plug 3.

FIG. 5 further discloses a perspective view of the spark plug 3 in isolation, which spark plug 3 is also used by the embodiments of FIG. 3 and 4.

In fact, the embodiment of FIG. 3 does essentially correspond to the embodiment shown by FIG. 2, apart from the spark plug 3.

The spark plug 3 shown by FIGS. 3-5 comprises a longitudinal extension along a longitudinal axis 4, wherein at a first end facing the combustion chamber when the spark plug 3 is mounted in the internal combustion engine a middle electrode 20 and three ground electrodes 21 are provided.

Therefore, there are spark gaps 22 are provided which are arranged between the middle electrode 20 and each of the three ground electrodes 21.

The spark gaps 22 of the spark plug 3 are arranged asymmetrically with respect to the middle electrode 20 and/or the longitudinal axis 4.

By use of such a spark plug 3 it is furthermore possible to move or arrange the spark gap 22 (and therefore the point of start of ignition) into an eccentrically position inside the pre-chamber volume 18.

To orient the spark plug (and therefore the eccentrical spark gaps 22) inside the pre-chamber volume 18 the positioning device 6 is used.

The three ground electrodes 21 of the spark plug 3 are arranged in an azimuthal area spanning approximate 120 degrees in relation to the longitudinal axis 4 and/or the middle electrode 20.

The spark plug 3 comprises a flow control element 24 surrounding the middle electrode 20 with respect to the longitudinal axis 4.

The flow control element 24 is arranged opposite of the three ground electrodes 21 with respect to the longitudinal axis 4.

The flow control element 24 is also arranged in an azimuthal area spanning approximately 120 degrees in relation to the longitudinal axis 4 and/or the at least one middle electrode 20.

As can be seen, the flow control element 24 is formed by a separate component part, which separate component part is arranged at the housing 25 of the spark plug 3. The housing 25 and the at least one separate component part are connected by welding, particularly preferably laser beam welding.

The flow control element 24 has a base shape of a part of a circular cylinder.

The ground electrode 20 comprises a central electrode carrier 26 extending along the longitudinal axis 4, wherein the middle electrode is attached to the electrode carrier 26.

The three ground electrodes 21 can be fixed by laser beam welding to the housing 25 of the spark plug 3.

### USED REFERENCE SIGNS

1 arrangement
2 igniter
3 spark plug
4 longitudinal axis
5 component part
6 positioning device
7 latch
8 centerline of the latch
9 pin
10 grab screw
11 locking profile
12 groove
13 bore
14 spark plug sleeve
15 ignition device
16 pre-chamber injector
17 pre-chamber component part
18 pre-chamber volume
19 pre-chamber gas channel
20 middle electrode
21 ground electrode
22 spark gap
23 transfer passages
24 flow control element
25 housing
26 central electrode carrier
27 mounting portion

1. An arrangement for an internal combustion engine, comprising:
an igniter configured to ignite an air fuel mixture; and
a component part configured to receive at least part of the igniter, wherein the igniter is disposed in the component part in a given azimuthal position relative to a longitudinal axis of the igniter, wherein a positioning device is configured to lock the igniter in the given azimuthal position.

2. The arrangement of claim 1, wherein the positioning device is securable or secured in the component part and/or integral with the component part.

3. The arrangement of claim 1, wherein the positioning device comprises a latch with a longitudinal extension along a centerline of the latch, wherein the centerline of the latch is provided oblique or orthogonal with respect to the longitudinal axis of the igniter.

4. The arrangement of claim 3, wherein the latch is provided in the form of a pin or by a grub screw.

5. The arrangement of claim 3, wherein the positioning device comprises a locking profile disposed on the igniter, wherein the latch and the locking profile cooperate for locking the igniter in the given azimuthal position.

6. The arrangement of claim 5, wherein the locking profile comprises a recess having a groove and/or a bore.

7. The arrangement of claim 1, wherein the igniter comprises a spark plug, and wherein the component part is a spark plug sleeve or a pre-chamber sleeve to position an ignition device of the igniter protruding into a combustion chamber and/or a pre-combustion volume of the internal combustion chamber.

8. The arrangement of claim 1, wherein the component part carries or provides a pre-chamber component part and the igniter is configured to ignite a combustible air-fuel mixture inside a pre-chamber volume of the pre-chamber component part.

9. The arrangement of claim 8, wherein at least one pre-chamber gas channel is provided for supplying air, fuel or an air-fuel mixture to the pre-chamber volume.

10. The arrangement of claim 1, wherein the igniter comprises at least one middle electrode and at least one ground electrode, wherein a spark gap is disposed between the at least one middle electrode and the at least one ground electrode.

11. The arrangement of claim 10, wherein the given azimuthal position of the igniter is provided in such a way that the supplied air, fuel or an air-fuel mixture via the pre-chamber gas channel is directed to the spark gap, middle electrode and/or ground electrode when entering the pre-chamber volume.

12. The arrangement of claim 11, wherein an exit part of the pre-chamber gas channel is aligned with the spark gap, middle electrode and/or ground electrode when the igniter is in the given azimuthal position.

13. A system, comprising:
an igniter of an internal combustion engine, wherein the igniter comprises a longitudinal axis and at least a part of a positioning device configured to lock the igniter in a given azimuthal position relative to the longitudinal axis in a state when the igniter is mounted in a component part of the internal combustion engine.

14. The system of claim 13, comprising the internal combustion engine having the igniter.

15. A method, comprising:
receiving an igniter in a component part of an internal combustion engine, wherein the igniter is configured to ignite an air fuel mixture; and
locking the igniter in a given azimuthal position relative to a longitudinal axis of the igniter via a positioning device.

16. The method of claim 15, wherein locking the igniter via the positioning device comprises engaging a latch with a locking profile.

17. The method of claim 16, wherein engaging the latch comprises engaging the latch with the locking profile on the igniter.

18. The method of claim 16, wherein the latch comprises a longitudinal extension along a centerline of the latch, and the centerline of the latch is provided oblique or orthogonal with respect to the longitudinal axis of the igniter.

19. The method of claim 18, wherein the locking profile comprises a recess.

20. The method of claim 15, wherein receiving the igniter in the component part comprises receiving the igniter in a pre-chamber component part.
